(19) United States
(12) Patent Application Publication
(10) Pub. No.: US 2004/0081130 A1
(43) Pub. Date: Apr. 29, 2004

(54) Communication system

(76) Inventor: Anu Virtanen, Espoo (FI)

Correspondence Address: SQUIRE, SANDERS & DEMPSEY L.L.P., 14TH FLOOR, 8000 TOWERS CRESCENT, TYSONS CORNER, VA, 22182, US

(21) Appl. No.: 10/469,024

(22) PCT Filed: Mar. 27, 2002
(86) PCT No.: PCT/IB02/02107

(51) Int. Cl. H04B 7/216

(52) U.S. Cl. 370/342; 370/345

(57) ABSTRACT

A method and a communication system is disclosed. In the method a first station is provided with information associated with a code structure. Said code structure defines how a second station has arranged channelisation codes for transmission of data. Data is then transmitted from the second station. Reception of said data at the first station is initiated based on said information associated with the code structure. Further information associated with said transmission of data is signalled simultaneously with the transmission of said data from the second station.

### FIELD OF THE INVENTION

The present invention relates to a communication system, and in particular, but not exclusively, to transmission of multiplexed data.

### BACKGROUND OF THE INVENTION

Various different communication systems adapted to provide wireless communication media between two or more stations are known. The wireless communication media may be provided between a station of a communication network and a user equipment. Wireless communication media may also be provided between two user equipment or between two stations of a communication network.

A wireless communication systems may be used for various types of communication, such as for communication of voice, image or other data and so on. In the so called packet data services data (e.g. speech data, user data, video data or other data) is communicated in data packets. The development in the wireless communication has lead to systems that are capable of transporting data in substantially high data rates i.e. the so called high speed data (HSD).

An example of wireless communication systems is a cellular communication system. In a cellular system the user equipment may access the communication network via access entities referred to as cells, hence the name cellular system. The skilled person knows the basic operational principles ad elements of a cellular network and these are therefore not explained herein in any great detail. It is sufficient to note that a cell can be defined as an radio access entity that is served by one or several base stations (BS). A base station serves user equipment (UE) via a wireless interface therebetween. Examples of the wireless cellular access networks include networks that are based on access systems such as the CDMA (Code Division Multiple Access), WCDMA (Wide-band CDMA), TDMA (Time Division Multiple Access), FDMA (Frequency Division Multiple Access), or SDMA (Space Division Multiple Access) and hybrids thereof.

Data may transmitted over several channels between a base station and user equipment. The channels may be operated independently. Modulation of data streams on the different channels may be based on an appropriate multiplexing technique, such as e.g. on time multiplexing or code multiplexing. At the receiving stations the transmissions from a single source on different channels can be separated by means of so called channelisation codes.

A receiving station may obtain the channelisation codes used for the transmission from a specific structure that is arranged to carry this information in a predefined manner. For example, in the 3^{rd} generation (3G) UMTS (Universal Mobile telecommunication Service) radio access system the channelisation codes from a source are proposed to be arranged in a so called code tree. The term code tree (or channelisation code tree) refers to a hierarchical arrangement of the codes that are provided from a single source for use in channelisation at the receiving station.

An example of the code tree for a downlink shared channel (DSCH) is shown in FIG. 1. As can be seen, a greater spreading factor (SF) can be used for codes in those positions in the code tree that are more remote from the root of the tree. Thus those codes that can be transmitted with as high spreading factor as possible will save the code tree resources. On the other hand, transmission of data with a high spreading factor takes more time than transmission of data with a low spreading factor.

Different base stations may operate their code trees independently from each other. In a typical arrangement there is thus no need to coordinate the usage of the code trees between the different base stations.

In order to enable multiplexed data transportation from the base station to the user equipment the user equipment may need to be provided with some information regarding the data transportation in order to be able to correctly receive and decode the data. For example, information that associates with the data carrying codes such as code multiplexing may need to be provided from the network side to the user equipment. The code multiplexing information may be information that associates with those code channels with which each user equipment should receive and decode from the network. Said information may include information such as the starting point in a high speed downlink packet access (HSDPA) code tree, and the number of code channels the user equipment should receive and decode.

Examples of other information that may be required include information that associates with the identification of the receiving user equipment. If the user equipment identity information is not provided, each user equipment needs to receive and process several code channels of a shared channel continuously, even if those packets would not belong to the corresponding user equipment. In addition, the user equipment may need to be provided with information associated with features such as a so called modulation and coding set (MCS), transmission power levels, fast hybrid automatic repeat request (FHARQ), signalling and so on.

There are several proposals how the network should signal information that associates with the code multiplexing and the data transmission in general to one or several user equipment. However, the inventor has found that these proposals involve some disadvantages. It is noted herein that these proposals do not necessarily constitute the state of the art.

One proposal is that all required code multiplexing information is sent before transmission of the high speed downlink packet access data. The information is transmitted on a dedicated control channel, the channel being dedicated to a certain user equipment. A problem in this is that the information transmission may involve transmission of a substantially high amount of bits to the user equipment. This could perhaps be addressed by sending these bits with as high spreading factor (SP) as possible, thereby saving capacity in the code tree.

However, if a high spreading factor is used, then the transmission of these parameters will take a substantially long time. This will reduce the available processing time for the actual high speed downlink packet access data decoding. It could also be possible to try to maximise the processing time for the high speed downlink packet access data decoding, and to transmit parameters associated with the code multiplexing within as short time period as possible. This may be done by using of a smaller spreading factor in order to fit all required parameters to e.g. within one timeslot. This in turn means that code tree capacity may be wasted.

Another proposal is that all information that relates to the code multiplexing is sent in parallel with the high speed downlink packet access data transmission. The information is indented to be sent in the shared control channel. This proposal has the advantage that capacity of the downlink code tree is saved, since this information does not need to be sent on the dedicated control channel. It may also be possible to save some processing time, since less bits needs to be sent beforehand on the dedicated control channels. These bits could then be sent at high spreading factor and short duration of time.

A problem of this proposal, however, lies in that if different user equipment capabilities need to be defined for the high speed downlink packet access (HSDPA) it is not possible to use the code multiplexing with full flexibility. It may be, for example, necessary to define that not all user equipment capability classes are required to receive the maximum number of code channels in the high speed downlink packet access code tree. There could be a user equipment capability that requires support for receiving only e.g. half (or ¼^{th} or so on) of the plurality of high speed downlink packet access code channels in the high speed downlink packet access code tree. The inventor has found that if all information required for the code multiplexing is transmitted in parallel to the high speed downlink packet access data transmission to a user equipment it may not be possible to allow code multiplexing for user equipment provided with different user equipment capabilities. In order to be able determine those codes that are meant for a user equipment the user equipment would also have to despread all code channels before the user equipment can obtain the information from the parallel control channel regarding the correct codes. This is so since the user equipment is able to decode the information about the starting point of the code tree that it should receive only after the whole transmission time interval (TTI) has passed. Thus the user equipment supporting e.g. only half of the HSDPA code tree cannot receive and despread only the first half of the HSDPA code tree and then decode the information sent on parallel regarding the codes the user equipment should receive. It would be too late to alter the decision that the user equipment should have actually received and despread the upper half of the HSDPA code tree even if the code multiplexing information would inform the user equipment of this.

Thus, if there is e.g. two user equipment supporting only the half of the plurality of high speed downlink packet access code channels, and if these user equipment both start receiving the Nmax/2 codes starting from the first code channel in the HSDPA code tree, then the base station may not be able to code multiplex the data to the two user equipment of this kind to the same transmission time interval (TTI) Only one user equipment could receive the data correctly whereas the other would receive and despread the wrong Nmax/2 code channels before said other user equipment could notice that it should have received the code channels starting from the code channel number Nmax/2 up to Nmax.

### SUMMARY OF THE INVENTION

Embodiments of the present invention aim to address one or several of the above problems.

According to one aspect of the present invention, there is provided a method in a communication system comprising: providing a first station with information associated with a code structure, said code structure defining how a second station has arranged channelisation codes for transmission of data; transmitting data from the second station; initiating reception of said data at the first station based on said information associated with the code structure; and signalling further information associated with said transmission of data simultaneously with the transmission of said data from the second station.

In a more specific embodiment said information associated with the code structure may be signalled before a corresponding data transmission interval. The data transmission interval may comprise a high speed downlink packet access transmission time interval.

Said information may be transmitted on a dedicated control channel. Said further information may be signalled in parallel with the data on a common control channel. The data may be transported on a shared data channel.

The information associated with the code structure may provide the first station with information regarding a starting point in the code structure. The starting points refers to a point from which he first station shall start receiving data from the second station. The code structure may comprise a code tree.

Said further information may comprise information that associates with the number of codes carrying the data the first station shall decode.

According to another aspect of the present invention there is provided a communication system comprising: a first station and a second station, wherein the first station is adapted to initiate reception of data from the second station based on information of a code structure, said code structure defining how the second station has arranged channelisation codes for said data transmission; first channel means for provision of said information from the second station to the first station; second channel means for transportation of data from the second station to the first station; and third channel means for provision of further information associated with said data transmission simultaneously with the transmission of said data from the second station.

According to another aspect of the present invention there is provided a user equipment adapted for data communication with a station of a communication system, the user equipment being adapted to initiate reception of data from the station based on information of a code structure, said code structure defining how the station has arranged channelisation codes for said data transmission, and comprising interface means for receiving from the station via first, second and third channel means, wherein the first channel means is for provision of said information, the second channel means is for transportation of data from the second station to the first station, and the third channel means is for provision of further information associated with said data transmission simultaneously with the transmission of said data from the second station.

According to another aspect of the present invention there is provided a base station adapted for data communication with a user equipment of a communication system, the base station being adapted to initiate transmission of data to the user equipment by providing the user equipment with information of a code structure, said code structure defining how the station has arranged channelisation codes For said data transmission, and comprising interface means for transmitting to the user equipment via first, second and third channel means, wherein the first channel means is for provision of said information, the second channel means is for transportation of data to the first station, and the third channel means is for provision of further information associated with said data transmission simultaneously with the transmission of said data.

The embodiments of the invention may provide distributed use of channel resources. By means of the separated transmission of information that associates with the code structure and information that associates with the actual data carrying codes it may be possible to avoid the above referenced problems. The embodiments may enable utilisation of code multiplexing while at the same time enabling use of a number of different user equipment capabilities. Not all user equipment in communication with the network need to support the maximum number of codes in the code structure.

### BRIEF DESCRIPTION OF DRAWINGS

For better understanding of the present invention, reference will now be made by way of example to the accompanying drawings in which:

FIG. 1 shows a code structure that may be provided by a station of a communication system;

FIG. 2 shows a wireless communication system wherein the present invention may be embodied;

FIG. 3 illustrates the timing between transportation of different parameters and data in accordance with an embodiment; and

FIG. 4 is a flowchart illustrating the operation of one embodiment of the present invention.

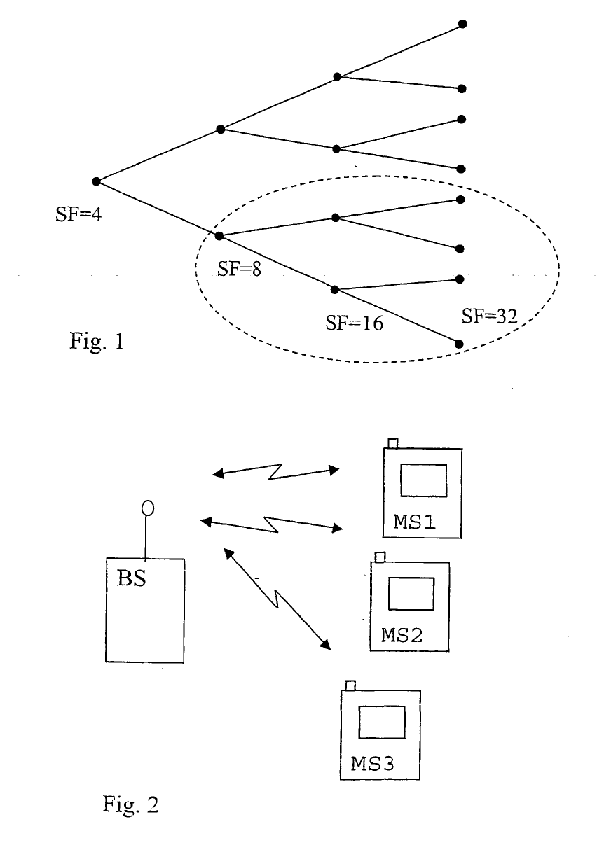

### DESCRIPTION OF PREFERRED EMBODIMENTS OF THE INVENTION

Before describing the preferred embodiments of the invention in more detail, a reference is made to FIG. 2 which is a block diagram illustrating a radio access system in which the present invention may be employed. More particularly, FIG. 2 shows a WCDMA system (Wideband Code Division Multiple Access) that allows a plurality of user equipment MS1, MS2, MS3 to communicate with a base (transceiver) station BS in a common cell. The radio access system of FIG. 2 is adapted to provide high speed downlink packet access (HSDPA) for the user equipment that are located within the service area thereof.

The communication may comprise transportation of data. Data to be transmitted between the user equipment MS1 to MS3 and the base transceiver station BS may be speech data, video data or other data. The data is encoded into a form suitable for transmission at a bit rate which is dependent on the application and the source of the data.

The communication between the base station BS and the user equipment MS1 to MS3 may occur via a plurality of channels. The base station may communicate in the downlink towards the user equipment via a shared data channel. Different communications are distinguished from one another by the use of combination of channelisation and scrambling codes. Use of channelisation and scrambling codes is a known operation in the art, and will thus not be explained in any great detail.

Each of the user equipment of FIG. 2 is shown to comprise a mobile station. A known feature of a mobile station is that it may move relative to the base station within the access entity (cell) and even from one access entity to another, hence the name mobile station.

Although not shown, a radio access network is typically provided with a controller entity such as a radio network controller or a base station controller. The skilled person is familiar with the required control functions and how these may be provided, and therefore it is not necessary to discuss the possible controller entities in more detail. It is sufficient to note that the access network controller entity may be connected further to another controller entity controlling the operation of several access controller entities. Said other controller entity may be provided in a core network side of the communication system.

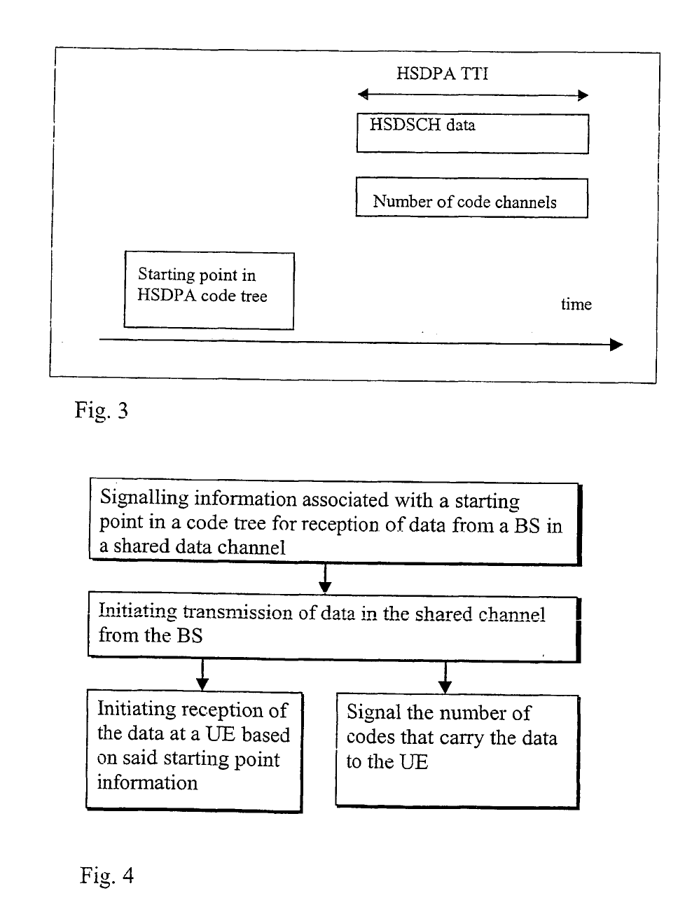

Preferred embodiments will now be discussed with reference also to FIGS. 3 and 4. The preferred embodiments relate to provision of information that associates with code multiplexing from the network side of a communication system to the user equipment. The information may be, for example, information associated with code channels with which each user equipment should receive and decode from the network.

The inventor has found that by separating transmission of information that associates with a code structure and information that associates with the data carrying codes it is possible to provide the user equipment with information that is required for the initiation of the reception. Any more detailed information regarding the data transportation can then be provided simultaneously with the data transportation.

Information regarding a parameter that is referred to as a high speed downlink packet access transmission time interval (HSDPA TTI) may be signalled to the user equipment. The high speed downlink packet access transmission time interval contains data that is transported to the user equipment via the high speed downlink shared channel (HSDSCH). The HSDPA TTI can be seen as a collection of a number of slots. Logically it can thus be seen to correspond the concept of data frames.

In accordance with an embodiment of the present invention, a network entity responsible for the transmission may signal the starting point of the high speed downlink shared channel (HSDSCH) in the high speed downlink packet access (HSDPA) code tree before initiating the transmission of the high speed downlink packet access transmission time interval (HSDPA TTI) the to the user equipment. The user equipment is thus provided with information regarding the point at which is shall start receiving data on the high speed downlink shared channel (HSDSCH).

The starting point k in the code tree may have values between k=1 . . . Nmax. The Nmax refers to the maximum number of code channels in the HSDPA code tree. For example, the 3GPP has proposed that in the WCDMA UMTS these values could be e.g.

Nmax=10 if the spreading factor SF=16, or Nmax=20, if the spreading factor SF=32.

The whole HSDPA code tree may be broadcast to the cell. The broadcasting may be arranged to occur via a broadcasting channel of the cell. The code tree information may be broadcast in one cell only or in a number of cells (e.g. in a cell and the neighbouring cells). The cell broadcasting as such is known and will thus not be explained in more detail. The network may also need to signal to the user equipment information associated with the exact number of codes that carry the HSDSCH data. In accordance with the principles of the present invention the provision of this information is separated from the provision of the code tree information.

FIG. 3 illustrates the timing of transmitting different parameters and/or data. As shown by FIG. 3, the number of codes is preferably transmitted in parallel with the high speed downlink shared channel (HSDSCH) data transmission, i.e. within the same high speed downlink packet access transmission time interval (HSDPA TTI) as the actual data. This information transmitted in parallel with the data will be referred to in the following as Ncodes.

It shall be appreciated that in a typical arrangement there may be as many control channels that are transmitted in parallel as there is codes of the different user equipment that are multiplexed to the same transmission time interval (TTI).

In addition to that it may be defined that the user equipment is required to receive, despread and buffer only up to N code channels. These proceedings may start from the code channel k an the high speed downlink packet access code tree, where

N=min((Nmax-k+1), Nue_cap),

where

Nmax is the maximum number of code channels in the HSDPA code tree, and

Nue_cap is a user equipment capability parameter defining how many multicodes the user equipment can receive simultaneously from the HSDPA code tree (multicode user equipment capability). Nue_cap may vary between 1 . . . Nmax.

The user equipment may thus obtain information from the control channel regarding the high speed downlink packet access (HSDPA) N data code channels that are meant for said user equipment. After the reception of this information the user equipment can do the actual decoding for the correct code channels. The information and the data are preferably transmitted in the same transmission time interval (TTI).

The parameter k defining the starting point of the code tree may be defined so that the number of values the parameter k may have is smaller than Nmax. Thus if there are limited number of bits for signalling the value of the parameter k to the user equipment, it is advantageous if it is defined beforehand what the various bit values for parameter k will mean. The following gives some examples for the mapping of a certain number of bits to certain values of parameter k when Nmax=10.

k=[1, Nmax/2+1]

=>needs only 1 bit for signalling this information

=>allows e.g. code multiplexing of two user equipment, each of which supports at least 5 multicodes

k=[1,2]

=>needs only 1 bit for signalling this information

=>allows code multiplexing of two user equipment, one supporting at least 1 multicode, the other supporting up to 9 multicodes

k=[1, 3, 5, 7]

=>needs 2 bits for signalling this information

=>allows e.g. code multiplexing of four user equipment,

or e.g. code multiplexing of two user equipment with a more flexible resolution.

The parameter Ncode, which defines the number of actual code channels to be decoded by the user equipment, can also be defined so that it has fewer possible values than what the Nmax is. The values of the Ncode may be predefined and matched to the values of k. For example, it may be defined that Ncode=[1,2,5,10], which would require only 2 bits for the signalling thereof.

The network entity controlling the base station may signal information defining the starting point in the high speed downlink packet access code tree before the high speed downlink packet access data transmission is initiated. In addition to that it is possible to define that the user equipment needs to receive, despread and buffer only upto that many code channels as its multicode user equipment capability defines. This facilitates use of the code multiplexing for the high speed downlink packet access such that different multicode user equipment capabilities are allowed for said high speed downlink packet access.

Also, if the signalling is divided so that only a part of the parameters are sent beforehand, this means that less bits are needed for the provision of this information. This requires less space either in the time domain or the spreading factor domain. Thus it is possible to both save the code tree, and avoid reducing the processing time too much.

It should be appreciated that whilst embodiments of the present invention have been described in relation to mobile user equipment, embodiments of the present invention are applicable to any other suitable type of user equipment.

The embodiment of the present invention has been described in the context of a WCDMA system. This invention may be embodied in any other system where applicable.

It should also be appreciated that base stations can sometimes be referred to as node B. In addition, the term cell is intended to cover also a group of cells in instances where more than one cell is controlled by a controller entity.

The embodiment of the invention has discussed the channels between a user equipment and a base station. Embodiments of the present invention can be applicable to other interfaces where applicable.

It is also noted herein that while the above describes exemplifying embodiments of the invention, there are several variations and modifications which may be made to the disclosed solution without departing from the scope of the present invention as defined in the appended claims.

1. A method in a communication system comprising:
providing a first station with information associated with a code structure, said code structure defining how a second station has arranged channelisation codes For transmission of data;
transmitting data from the second station;
initiating reception of said data at the first station based on said information associated with the code structure; and
signalling further information associated with said transmission of data simultaneously with the transmission of said data from the second station.

2. A method as claimed in claim 1, wherein said information associated with the code structure is signalled before a corresponding data transmission interval.

3. A method as claimed in claim 2, wherein the data transmission interval comprises a high speed downlink packet access transmission time interval.

4. A method as claimed in any preceding claim, wherein said information is transmitted on a dedicated control channel.

5. A method as claimed in claim 4, wherein the control channel is dedicated for the first station.

6. A method as claimed in any preceding claim, wherein said further information is signalled in parallel with the data on a common control channel.

7. A method as claimed in claim 6, wherein the common control channel comprises a shared control channel of a third generation communication system.

8. A method as claimed in any preceding claim, wherein the information associated with the code structure provides the first station with information regarding a starting point in the code structure from which the first station shall start receiving data from the second station.

9. A method as claimed in any preceding claim, wherein the code structure comprises a code tree.

10. A method as claimed in any preceding claim, wherein said further information comprises information that associates with the number of codes carrying the data the first station shall decode.

11. A method as claimed in any preceding claim, wherein the data is transported on a shared data channel.

12. A method as claimed in claim 11, wherein the shared data channel comprises a high speed downlink shared channel.

13. A method as claimed in any preceding claim, wherein the first station comprises a mobile user equipment and the second station comprises a base station of the communication system.

14. A communication system comprising:
a first station and a second station, wherein the first station is adapted to initiate reception of data from the second station based on information of a code structure, said code structure defining how the second station has arranged channelisation codes for said data transmission;
first channel means for provision of said information from the second station to the first station;
second channel means for transportation of data from the second station to the first station; and
third channel means for provision of further information associated with said data transmission simultaneously with the transmission of said data from the second station.

15. A communication system as claimed in claim 14, wherein said information associated with the code structure is adapted to be signalled to the first station before the start of a corresponding data transmission interval.

16. A communication system as claimed in claim 15, wherein the data transmission interval comprises a high speed downlink packet access transmission time interval.

17. A communication system as claimed in any of claims 14 to 16, wherein said first channel means comprise a dedicated control channel.

18. A communication system as claimed in any of claims 14 to 17, wherein said third channel means comprise a common control channel.

19. A communication system as claimed in any of claims 14 to 18, wherein the information associated with the code structure provides the first station with information regarding a starting point in the code structure from which the first station shall start receiving data from the second station.

20. A communication system as claimed in any of claims 14 to 19, wherein the code structure comprises a code tree.

21. A communication system as claimed in any of claims 14 to 20, wherein said further information comprises information that associates with the number of codes carrying the data the first station shall decode.

22. A communication system as claimed in any of claims 14 to 21, wherein the second channel comprises a shared data channel.

23. A communication system as claimed in any of claims 14 to 22, wherein the first station comprises a mobile user equipment.

24. A communication system as claimed in any of claims 14 to 23, wherein the second station comprises a base station.

25. A user equipment adapted for data communication with a station of a communication system, the user equipment being adapted to initiate reception of data from the station based on information of a code structure, said code structure defining how the station has arranged channelisation codes for said data transmission, and comprising interface means for receiving from the station via first, second and third channel means, wherein the first channel means is for provision of said information, the second channel means is for transportation of data from the second station to the first station, and the third channel means is for provision of further information associated with said data transmission simultaneously with the transmission of said data from the second station.

26. A base station adapted for data communication with a user equipment of a communication system, the base station being adapted to initiate transmission of data to the user equipment by providing the user equipment with information of a code structure, said code structure defining how the station has arranged channelisation codes for said data transmission, and comprising interface means for transmitting to the user equipment via first, second and third channel means, wherein the first channel means is for provision of said information, the second channel means is for transportation of data to the first station, and the third channel means is for provision of further information associated with said data transmission simultaneously with the transmission of said data.
